(19) United States
(12) Patent Application Publication
(10) Pub. No.: US 2016/0023331 A1
(43) Pub. Date: Jan. 28, 2016

(54) DIS/ASSEMBLING PLIER FOR A CONNECTOR

(71) Applicant: Jun-Fan CHEN, Taichung (TW)

(72) Inventor: Jun-Fan CHEN, Taichung (TW)

(21) Appl. No.: 14/341,800

(22) Filed: Jul. 26, 2014

(51) Int. Cl. B25B 7/12; B25B 27/14; B25B 7/02

(52) U.S. Cl. CPC B25B 7/12; B25B 7/02; B25B 27/14

(57) ABSTRACT

A dis/assembling plier for a connector is provided, including a first clamping body, a driving lever and a clamping member. The first clamping body includes a first grip portion, a first clamping portion and a body portion connected between the first grip portion and the first clamping portion, and the body portion is formed with a first pivoting portion and a second pivoting portion. The driving lever is pivoted with the first pivoting portion and includes a second grip portion and a driving tooth portion disposed on two opposite ends of the first pivoting portion. The clamping member is pivoted with the second pivoting portion and includes a second clamping portion and a passive tooth portion disposed on two opposite ends of the second pivoting portion. The passive tooth portion is engaged with the driving tooth portion and rotatable around the second pivoting portion.

### BACKGROUND OF THE INVENTION

1. Field of the Invention

The present invention relates to a dis/assembling plier, and more particularly to a dis/assembling plier for a connector.

2. Description of the Prior Art

When disassembling connectors from devices (such as air conditioners, vehicles or machines), an operator usually holds the connector by a hand and pushes a fastening end to move and disassemble a pipeline with another hand, or uses a clamping member of a vice to clamp the fastening end of the connector and move back to disassemble the pipeline. It takes a lot of power to disassemble the connector by hand and it is easy to hurt the hand. While it saves the power and avoids hurting by using the vice, but the clamping member of the vice easily damages and scratches the fastening end. And a prior art of a disassembling tool for disassembling the connector is disclosed in TWM369217.

However, though the disassembling tool for the connector has the clamping member for clamping and disassembling the connector, but it unequips with a mechanism for saving power. It is inconvenient for a user to use for a long time and makes the user feel tired. These disadvantages need to be solved. The present invention has arisen to mitigate and/or obviate the afore-described disadvantages.

### SUMMARY OF THE INVENTION

The primary object of the present invention is to provide a dis/assembling plier for a connector, having an efficiency of saving time and power in disassembling/assembling a pipeline with the connector. And a clamping portion of the dis/assembling plier corresponds to the connector in structure, and it prevents the connector from damaging.

To achieve the above object, a dis/assembling plier for a connector in accordance with present invention includes a first clamping body, a driving lever and a clamping member. The first clamping body includes a first grip portion, a first clamping portion and a body portion connected between the first grip portion and the first clamping portion, and the body portion is formed with a first pivoting portion and a second pivoting portion. The driving lever is pivoted with the first pivoting portion and includes a second grip portion and a driving tooth portion disposed on two opposite ends of the first pivoting portion. The clamping member is pivoted with the second pivoting portion and includes a second clamping portion and a passive tooth portion disposed on two opposite ends of the second pivoting portion. The passive tooth portion is engaged with the driving tooth portion and rotatable around the second pivoting portion.

### BRIEF DESCRIPTION OF THE DRAWINGS

FIG. 1 is a three-dimensional drawing of a dis/assembling plier in accordance with a preferable embodiment of the present invention;

FIG. 2 is a breakdown drawing of the dis/assembling plier in accordance with the preferable embodiment of the present invention;

FIG. 3 is a perspective drawing of the dis/assembling plier in accordance with the preferable embodiment of the present invention in operation;

FIG. 4 is another perspective drawing of the dis/assembling plier in accordance with the preferable embodiment of the present invention in operation.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

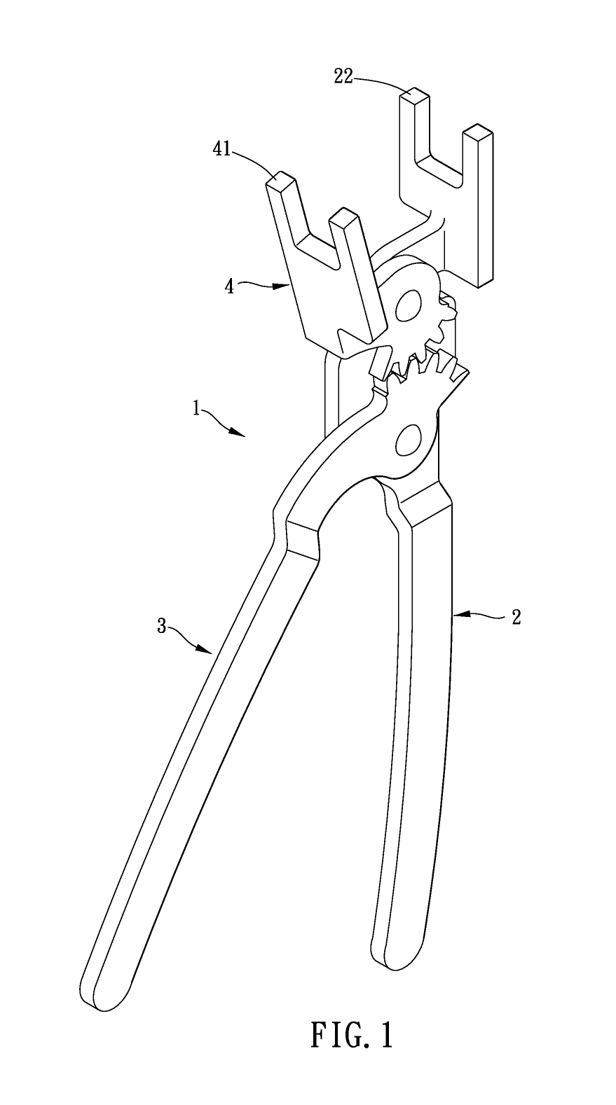

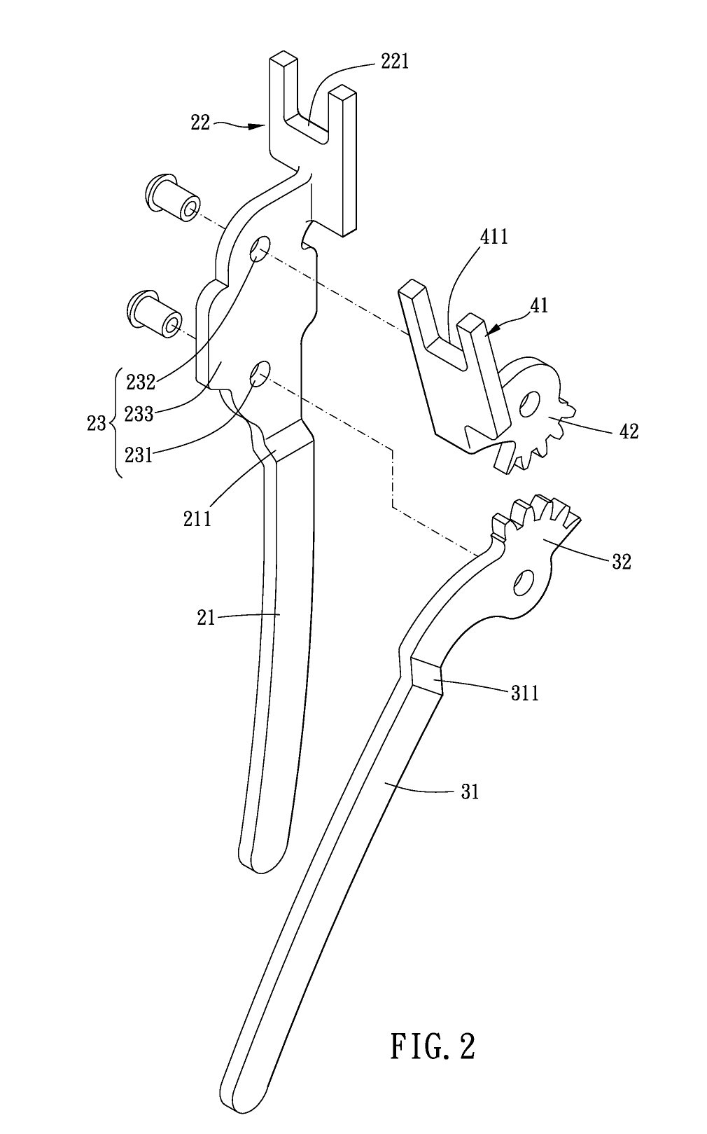

Referring to FIGS. 1-2, a dis/assembling plier 1 for connectors in accordance with a preferred embodiment of the present invention comprises a first clamping body 2, a driving lever 3 and a clamping member 4. (In here, dis/assembling means disassembling and assembling.)

The first clamping body 2 includes a first grip portion 21, a first clamping portion 22 and a body portion 23 connected between the first grip portion 21 and the first clamping portion 22. The body portion 23 is formed with a first pivoting portion 231 and a second pivoting portion 232. The body portion 23 includes a plate member 233. The first grip portion 21 is formed with a first bending portion 211 so that the plate member 233 and the first grip portion 21 are located on different planes. Practically, the first pivoting portion 231 and the second pivoting portion 232 are disposed on the plate member 233 of the body portion 23. The first clamping portion 22 is extended integrally from the body portion 23 and perpendicular to the body portion 23.

The driving lever 3 is pivoted with the first pivoting portion 231. The driving lever 3 includes a second grip portion 31 and a driving tooth portion 32 disposed on two opposite ends of the first pivoting portion 231. The second grip portion 31 includes a second bending portion 311. Preferably, the second bending portion 311 has a smaller curvature so that the first grip portion 21 and the second grip portion 31 are located on a same plane. When a user pushes the first grip portion 21 and the second grip portion 31 of the dis/assembling plier 1 moving on a plane, a pushing force is applied efficiently and undispersed.

The clamping member 4 is pivoted with the second pivoting portion 232. The clamping member 4 includes a second clamping portion 41 and a passive tooth portion 42 disposed on two opposite ends of the second pivoting portion 232. The second clamping portion 41 is connected integrally with the passive tooth portion 42 and perpendicular to the passive tooth portion 42. The second clamping portion 41 is opposite to the first clamping portion 22. The passive tooth portion 42 is engaged with the driving tooth portion 32 and rotatable around the second pivoting portion 232. The passive tooth portion 42, the driving tooth portion 32 and the first grip portion 21 are located on a same plane so that when pushing the first grip portion 21 and the second grip portion 31, the pushing force and a torque applied on the driving tooth portion 32 and the passive tooth portion 42 are on a same plane, and a force transmitting between the driving tooth portion 32 and the passive tooth portion 42 is undispersed. Furthermore, a rotating radius of which the driving tooth portion 32 rotates around the first pivoting portion 231 is greater than that of which the passive tooth portion 42 rotates around the second pivoting portion 232 so that when pushing the second grip portion 31 and the first grip portion 21 to come close to each other, there is a larger clamping force between the first clamping portion 22 and the second clamping portion 41. It helps the user to operate easily.

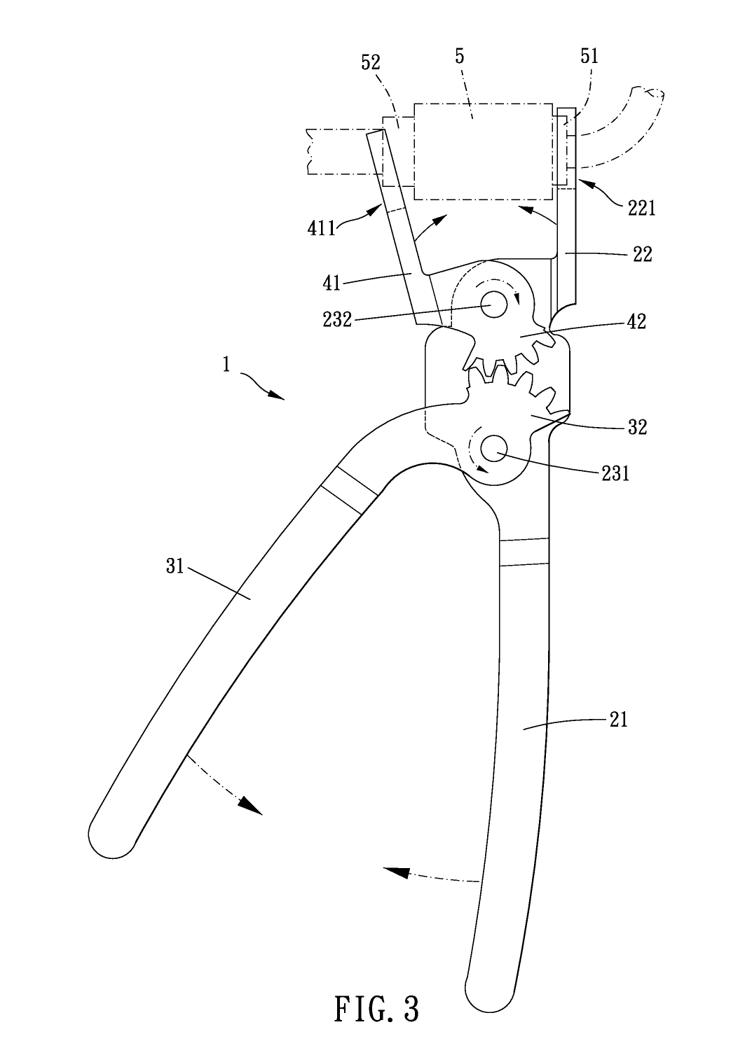

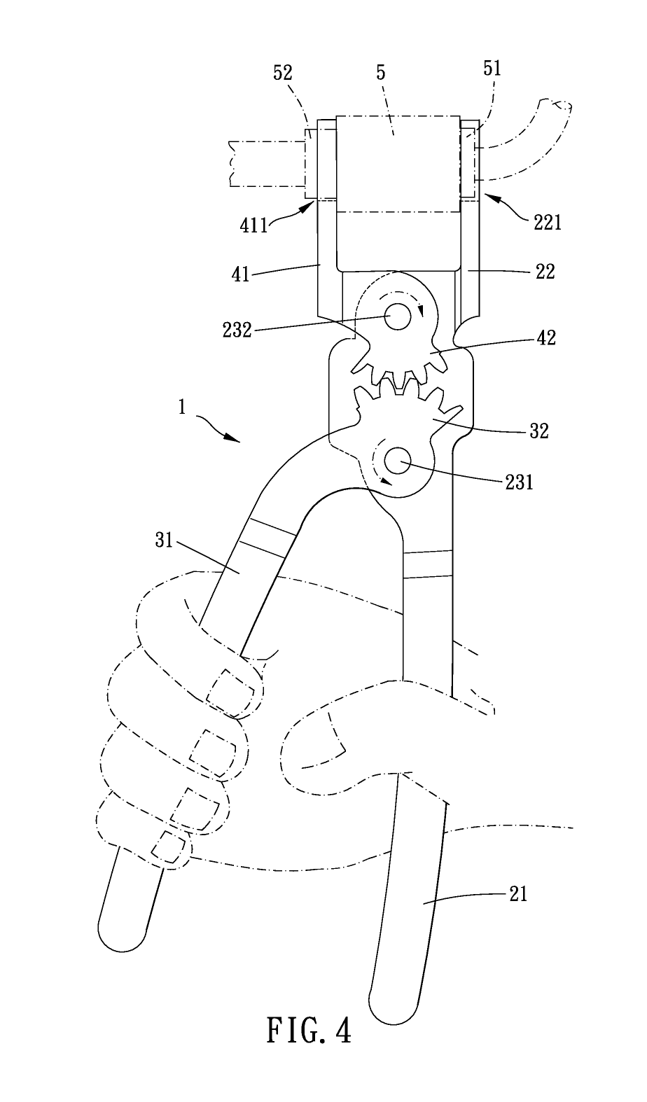

Referring to FIGS. 3-4, in the present embodiment, the first clamping portion 22 and the second clamping portion 41 respectively include a first U-shaped opening 221 and a second U-shaped opening 411. A fastening end 51 and a bottom end 52 of a connector 5 are clamped by pushing the first U-shaped opening 221 and the second U-shaped opening 411 to come close to each other. And a pipeline connected with the connector 5 is disassembled by clamping and moving the fastening end 51. In other embodiments, one of the first clamping portion 22 and the second clamping portion 41 is formed the first U-shaped opening, while the other one is unformed with the second U-shaped opening, and this design is convenient for assembling the pipeline to the connector 5.

It is noted that, in the present embodiment, the first clamping body 2, the driving lever 3 and the clamping member 4 are integrally formed so that the dis/assembling plier 1 has a strong structure and is easy and convenient for producing. In other embodiments, the first clamping body 2, the driving lever 3 or the clamping member 4 can be nonintegrally formed to meet a different demand.

Practically, when holding the first grip portion 21 and the second grip portion 31 by a hand and pushing the second grip portion 31 to come close to the first grip portion 21 (as shown in a direction of an arrow), the driving tooth portion 32 of the driving lever 3 rotates around the first pivoting portion 231, and the driving tooth portion 32 is engaged with the passive tooth portion 42 of the clamping member 4. The driving tooth portion 32 drives the passive tooth portion 42 to rotate around the second pivoting portion 232. And the second clamping portion 41 of the clamping member 4 and the first clamping portion 22 of the first clamping body 2 come close to each other to clamp the fastening end 51 and the bottom end 52 of the connector 5 and move the fastening end 51, and the pipeline connected with the connector 5 is disassembled.

As a conclusion, the dis/assembling plier for connectors of the present invention is formed with the passive tooth portion and the driving tooth portion and it is easy and efficient to operate with a force induced by double levers. Furthermore, the passive tooth portion, the driving tooth portion and the first grip portion move on a same plane so that when pushing the first grip portion and the second grip portion, the pushing force and a torque transmitted between the driving tooth portion and the passive tooth portion are on a same plane, and a force transmitting between the driving tooth portion and the passive tooth portion is undispersed.

Besides, the clamping portion corresponds to the connector in structure and it avoids that the connector is damaged. A rotating radius of which the driving tooth portion rotates around the first pivoting portion is greater than that of which the passive tooth portion rotates around the second pivoting portion so that when pushing the second grip portion and the first grip portion to come close to each other, a larger clamping force is induced between the first clamping portion and the second clamping portion. It is easy for a user to operate and has an efficiency of saving time and power when disassembling the pipeline of the connector.

While we have shown and described various embodiments in accordance with the present invention, it should be clear to those skilled in the art that further embodiments may be made without departing from the scope of the present invention.

What is claimed is:

1. A dis/assembling plier for a connector, comprising:
a first clamping body, including a first grip portion, a first clamping portion and a body portion connected between the first grip portion and the first clamping portion, the body portion formed with a first pivoting portion and a second pivoting portion;
a driving lever, pivoted with the first pivoting portion, including a second grip portion and a driving tooth portion disposed on two opposite ends of the first pivoting portion;
a clamping member, pivoted with the second pivoting portion, including a second clamping portion and a passive tooth portion disposed on two opposite ends of the second pivoting portion, the second clamping portion opposite to the first clamping portion, the passive tooth portion engaged with the driving tooth portion and rotatable around the second pivoting portion.

2. The dis/assembling plier as claimed in claim 1, wherein the body portion includes a plate member, the plate member and the first grip portion are located on different planes, the first pivoting portion and the second pivoting portion are disposed on the plate member, and the passive tooth portion, the driving tooth portion and the first grip portion are located on a same plane.

3. The dis/assembling plier as claimed in claim 2, wherein the first grip portion and the second grip portion are located on a same plane.

4. The dis/assembling plier as claimed in claim 1, wherein the first clamping portion is extended integrally from the body portion and perpendicular to the body portion.

5. The dis/assembling plier as claimed in claim 1, wherein the second clamping portion is connected integrally with the passive tooth portion and perpendicular to the passive tooth portion.

6. The dis/assembling plier as claimed in claim 1, wherein one of the first clamping portion and the second clamping portion includes a first U-shaped opening.

7. The dis/assembling plier as claimed in claim 1, wherein the first clamping portion and the second clamping portion respectively include a first U-shaped opening and a second U-shaped opening.

8. The dis/assembling plier as claimed in claim 1, wherein a rotating radius of the driving tooth portion rotating around the first pivoting portion is greater than that of the passive tooth portion rotating around the second pivoting portion.

9. The dis/assembling plier as claimed in claim 1, wherein the first clamping body is integrally formed.

10. The dis/assembling plier as claimed in claim 1, wherein the driving lever is integrally formed.

11. The dis/assembling plier as claimed in claim 1, wherein the clamping member is integrally formed.
